(19) United States
(12) Patent Application Publication
(10) Pub. No.: US 2026/0095386 A1
(43) Pub. Date: Apr. 2, 2026

(54) GROUP-BASED MANAGEMENT OF ARTIFICIAL INTELLIGENCE AND MACHINE LEARNING MODELS

(71) Applicant: QUALCOMM Incorporated, San Diego, CA (US)

(72) Inventors: Jay Kumar SUNDARARAJAN, San Diego, CA (US); Chenxi HAO, Beijing (CN); Taesang YOO, San Diego, CA (US); Naga BHUSHAN, San Diego, CA (US)

(21) Appl. No.: 19/101,453

(22) PCT Filed: Nov. 4, 2022
(86) PCT No.: PCT/CN2022/129892

§ 371 Date: Feb. 5, 2025

(51) Int. Cl. H04L 41/16; H04L 41/5003

(52) U.S. Cl. CPC H04L 41/16; H04L 41/5003

(57) ABSTRACT

Wireless communication devices, systems, and methods related to managing artificial intelligence (AI) and/or machine learning (ML) models are provided. For example, a method of wireless communication performed by a network unit may include transmitting, to one or more first user equipments (UEs), an indication of a first group identifier, wherein the first group identifier is based, at least in part, on one or more first machine learning (ML) models associated with the one or more first UEs; and transmitting, to at least one UE of the one or more first UEs, a first group-based signal associated with the first group identifier.

### TECHNICAL FIELD

This application relates to wireless communications, and more particularly to methods—and associated devices and systems—for managing artificial intelligence (AI) and/or machine learning (ML) models.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing may extend the benefit of NR technologies to operating entities that may not have access to a licensed spectrum.

In a wireless communication network, a BS may communicate with a UE in an uplink direction and a downlink direction. The radio frequency channel through which the BS and the UE communicate may have several channel properties that are considered for proper channel performance. The BS and UE may perform channel sounding to better understand these channel properties by measuring and/or estimating various parameters of the channel, such as delay, path loss, absorption, multipath, reflection, fading, doppler effect, among others. These channel measurements may also be used for channel estimation and channel equalization.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a network unit includes transmitting, to one or more first user equipments (UEs), an indication of a first group identifier, wherein the first group identifier is based, at least in part, on one or more first machine learning (ML) models associated with the one or more first UEs; and transmitting, to at least one UE of the one or more first UEs, a first group-based signal associated with the first group identifier. Associated devices, systems, means, and/or non-transitory computer readable media having one or more instructions for execution by one or more processors of a UE are also provided.

In an additional aspect of the disclosure, a method of wireless communication performed by a user equipment (UE) includes receiving, from a network unit, an indication of a first group identifier associated with the UE, wherein the first group identifier is based, at least in part, on one or more machine learning (ML) models associated with the UE; and receiving, from the network unit, a group-based signal associated with the first group identifier. Associated devices, systems, means, and/or non-transitory computer readable media having one or more instructions for execution by one or more processors of a network unit are also provided.

In an additional aspect of the disclosure, a network unit includes a memory device; a transceiver; and a processor in communication with the processor and the transceiver, wherein the network unit is configured to: transmit, to one or more first user equipments (UEs), an indication of a first group identifier, wherein the first group identifier is based, at least in part, on one or more first machine learning (ML) models associated with the one or more first UEs; and transmit, to at least one UE of the one or more first UEs, a first group-based signal associated with the first group identifier.

In an additional aspect of the disclosure, a user equipment (UE) includes a memory device; a transceiver; and a processor in communication with the processor and the transceiver, wherein the UE is configured to: receive, from a network unit, an indication of a first group identifier associated with the UE, wherein the first group identifier is based, at least in part, on one or more machine learning (ML) models associated with the UE; and receive, from the network unit, a group-based signal associated with the first group identifier.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention may include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects may be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a signaling diagram for machine learning (ML) model management according to one or more aspects of the present disclosure.

FIG. 4 illustrates a wireless communication network implementing group-based ML model management according to some aspects of the present disclosure.

FIG. 5 illustrates a signaling diagram for ML model management according to one or more aspects of the present disclosure.

FIG. 6 illustrates a chart showing ML model compatibility according to one or more aspects of the present disclosure.

FIG. 7 illustrates a block diagram of a user equipment (UE) according to one or more aspects of the present disclosure.

FIG. 8 illustrates a block diagram of a network unit according to one or more aspects of the present disclosure.

FIG. 9 illustrates a flow diagram of a wireless communication method according to some aspects of the present disclosure.

FIG. 10 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mm Wave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3 GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, and/or as instructions stored on a computer readable medium for execution on a processor or computer. Furthermore, an aspect may comprise at least one element of a claim.

In 5G NR, machine learning (ML) algorithms are being implemented to assist cellular network performance. These ML algorithms may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

At each node implemented with one or more ML algorithms, the ML algorithms may interact with different layers within the node. The ML algorithms may interact with one of the physical layer (PHY), the media access control (MAC) layer or upper layers (e.g., application layer) in some instances, or with multiple layers in other instances. These ML algorithms may involve various ML-related data transfers between different layers of different nodes (e.g., UE, BS, central cloud server). The ML algorithms may be trained with training datasets that are produced through periodic and/or aperiodic data collection at one or more nodes. In various aspects, measurement data collection serves as input to the ML modules. The operation of these ML algorithms at the different nodes may be used for ML model parameter transfer and/or update. The ML model framework within the wireless communication network has the capability to send feedback signals and/or reports between the different nodes. In various aspects, the UE may feedback channel measurements that are indicative of the ML model prediction accuracy. For example, the measurement data collection by the UE may be sent to the BS and/or central cloud server with a report may indicate that the ML model is producing prediction errors, thus indicative that the ML model has failed and/or requires updating.

In various aspects, the UE may include different ML algorithms on board to predict channel properties for a future use of that channel. For example, the machine learning-based network may be implemented by a channel property prediction network to predict one or more properties of a channel and/or one or more beam parameters. In some aspects, the ML algorithms are tasked to predict what transmission beam(s) to use for the BS and/or reception beam(s) to use for the UE. For example, the machine learning-based network may be implemented by a beam selection prediction network to predict the BS transmission beam(s) and/or the UE reception beam(s).

Various aspects relate generally to wireless communication and more particularly to group-based management of machine learning (ML) models. Some aspects more specifically relate to grouping UEs based on ML models associated with the UEs. In this regard, the UEs may be grouped based on UEs using (or capable of using) a common ML model (e.g., the same ML model), UEs using (or capable of using) ML models compatible with a common ML model of a network unit (e.g., the ML models used by each UE of the group are compatible with the same ML model of the network unit), UEs using (or capable of using) an ML model based on a common original ML model (e.g., the ML models used by each UE of the group are based on the same starting ML model, but may have been fine-tuned and/or otherwise refined or updated for each UE). Each UE group may have a corresponding group identifier. The group identifier may be utilized to facilitate group-based communications between a network unit and one or more UEs of the group. In this regard, the network unit may manage ML model operations, including any associated and/or related parameters, and/or other aspects of the wireless communication network in a group-based manner. For example, the network unit may utilize a group-based signal to indicate to switch from an active ML model to a different ML model (or switch to non-ML model based operation), indicate to monitor performance of an ML model, indicate to update an ML model (e.g., based on updated data and/or parameters), and/or indicate to take a particular action.

Particular aspects of the subject matter described in this disclosure may be implemented to realize one or more of the following potential advantages. A benefit of the group-based ML model management of this disclosure is that ML model activation, deactivation, fallback, and/or switching that may affect multiple UEs (or all UEs) using an ML model may be conveyed efficiently using group-based signaling. In some examples, by utilizing the ML model group-based signaling, the described techniques may be used to improve network efficiency, improve allocation of network resources, reduce power consumption by the UEs and/or the network units, and/or improve utilization of ML models. For example, by using group-based communications instead of separate communications for each UE, network overhead is reduced, thereby improving network efficiency and reducing power consumption of at least the network unit. Further, by using group-based communications instead of separate communication for each UE, it is more likely that all UEs in a group may be timely instructed to take one or more actions compared to separately scheduling communications for each UE. Additional aspects and advantages will be apparent from the following description and associated drawings.

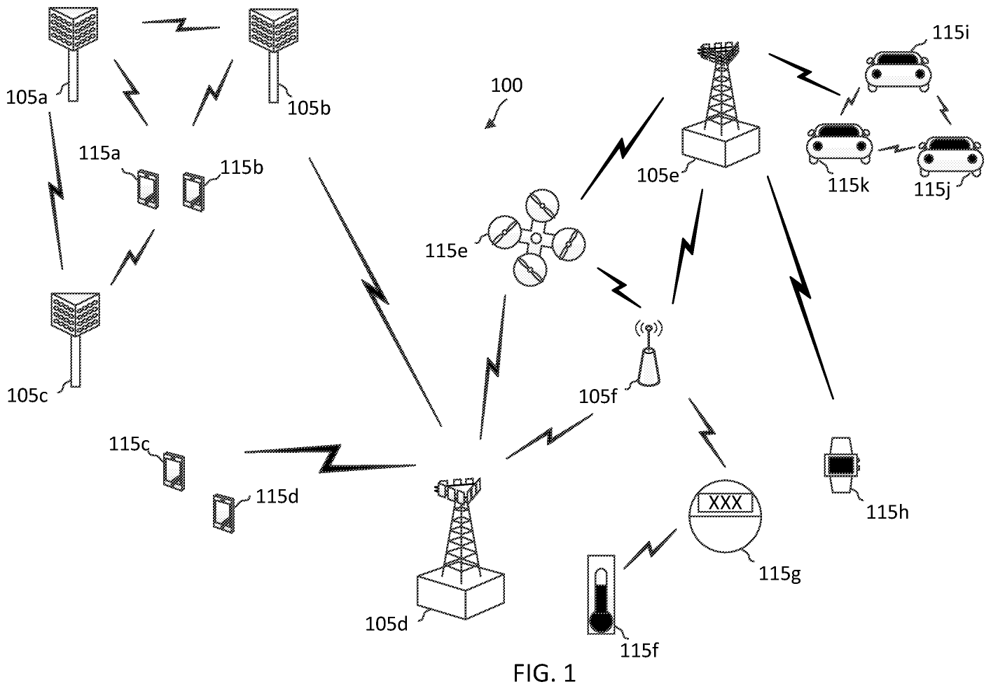

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” may refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL and/or UL, desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 may assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication may be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes may be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal may have a particular pilot pattern or structure, where pilot tones may span across an operational BW or frequency band, each positioned at a pre-defined time and a pre-defined frequency. For instance, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe may be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 may transmit synchronization signals (e.g., including a primary synchronization signal (PSS) and a secondary synchronization signal (SSS)) in the network 100 to facilitate synchronization. The BSs 105 may broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 may perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response may be referred to as message 1 (MSG1), message 2 (MSG2), message 3 (MSG3), and message 4 (MSG4), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 may enter a normal operation stage, where operational data may be exchanged. For instance, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For instance, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 may move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

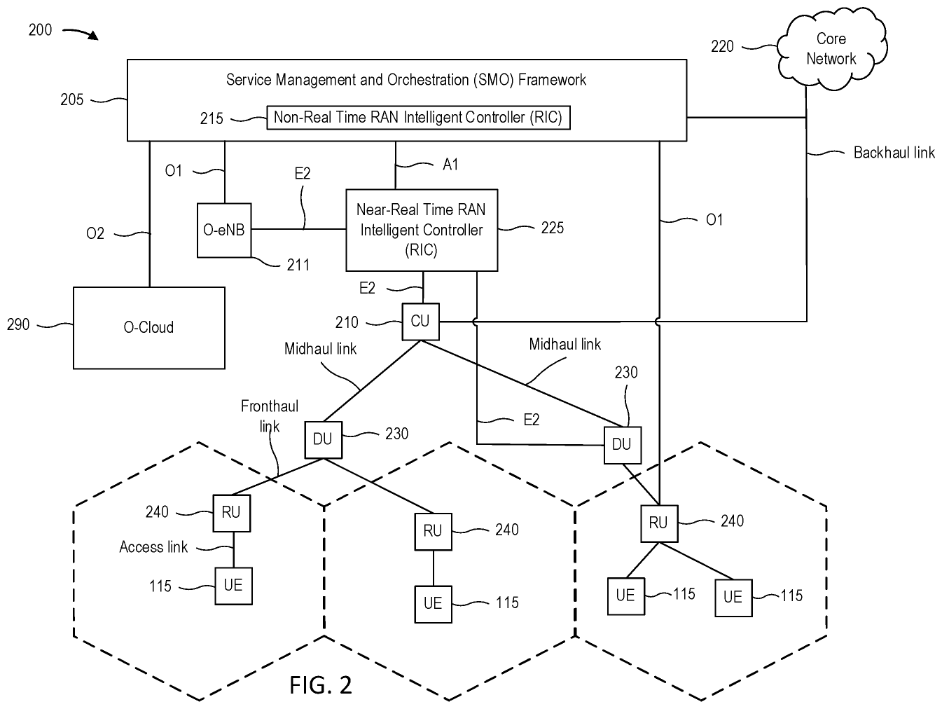

FIG. 2 shows a diagram illustrating an example disaggregated base station 200 architecture. The disaggregated base station 200 architecture may include one or more central units (CUs) 210 that may communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 may be logically split into one or more CU-UP units and one or more CU-CP units. The CU-UP unit may communicate bidirectionally with the CU-CP unit via an interface, such as the E1 interface when implemented in an O-RAN configuration. The CU 210 may be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) may be implemented with an interface configured to communicate signals with other layers (and modules) hosted by the DU 230, or with the control functions hosted by the CU 210.

Lower-layer functionality may be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 may be implemented to handle over the air (OTA) communication with one or more UEs 115. In some implementations, real-time and non-real-time aspects of control and user plane communication with the RU(s) 240 may be controlled by the corresponding DU 230. In some scenarios, this configuration may enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements may include, but are not limited to, CUs 210, DUs 230, RUs 240 and Near-RT RICs 225. In some implementations, the SMO Framework 205 may communicate with a hardware aspect of a 4G RAN, such as an open eNB (O-eNB) 211, via an O1 interface. Additionally, in some implementations, the SMO Framework 205 may communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

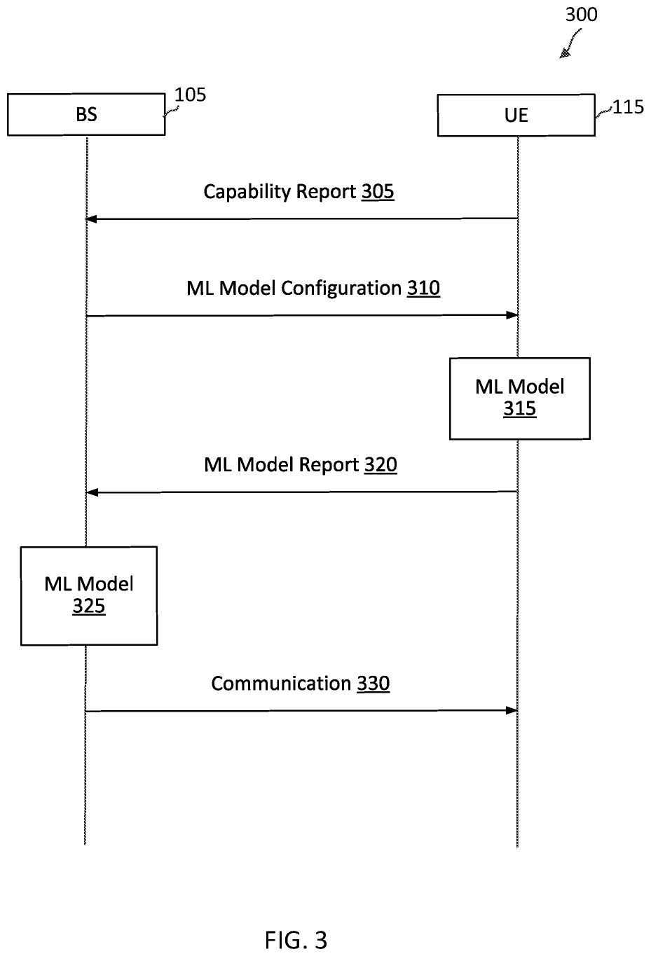

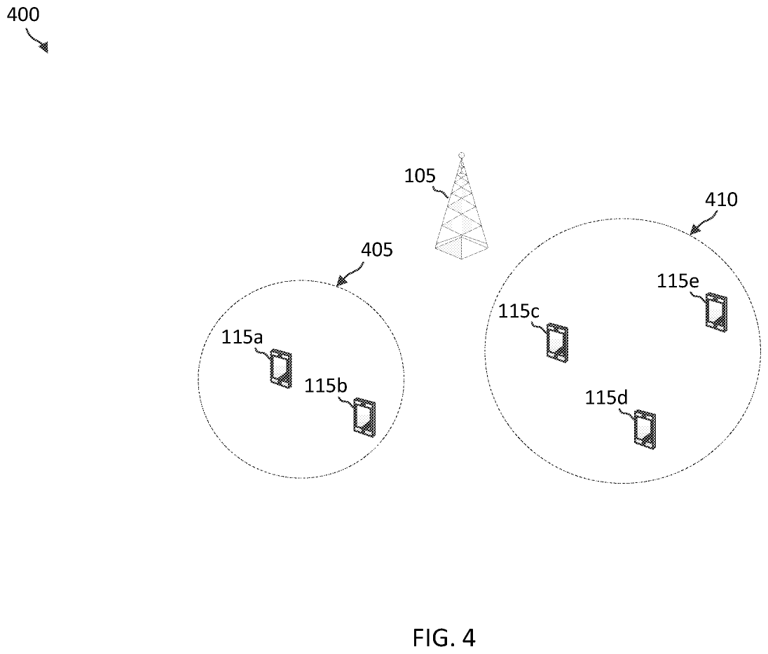

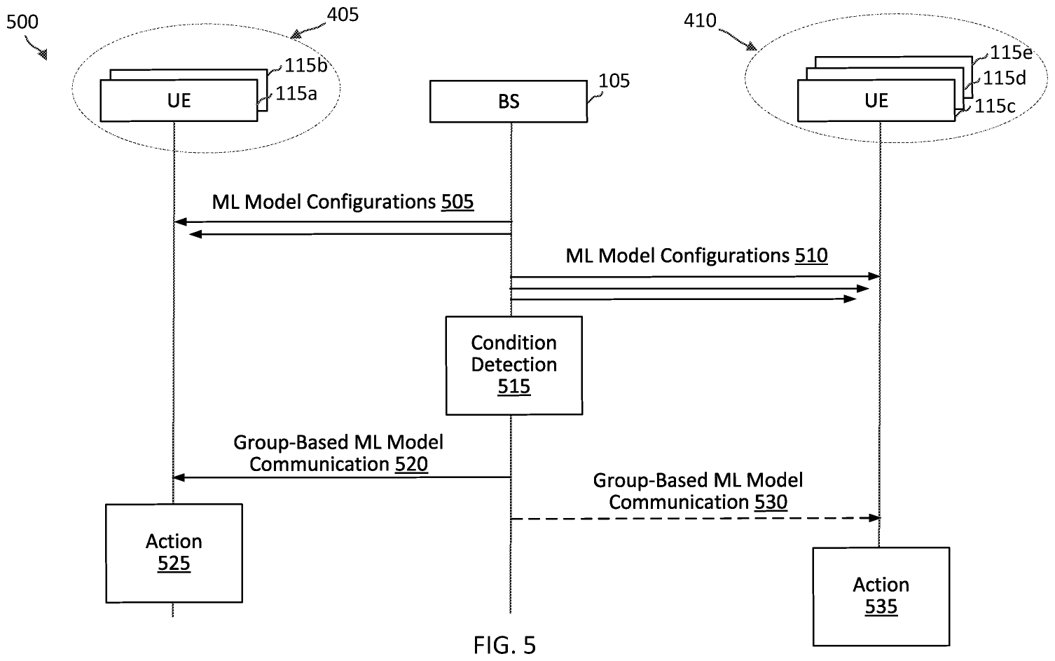

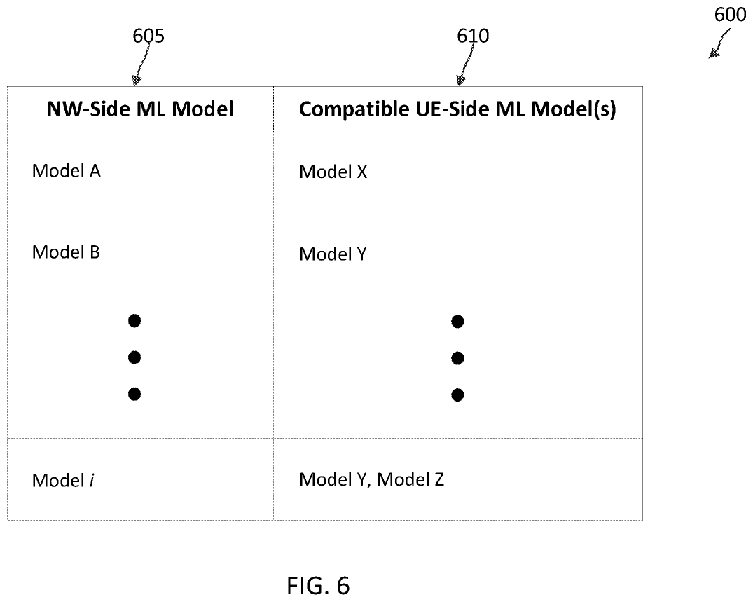

FIG. 3 illustrates a signaling diagram 300 for machine learning (ML) model management according to one or more aspects of the present disclosure. The signaling diagram 300 illustrates aspects of ML model management in accordance with the present disclosure. In this regard, aspects of the ML model management shown in signaling diagram 300 may be utilized in the context of the wireless communication network 100 as well as with other aspects of the present disclosure, including aspects of wireless communication network 400, aspects of the group-based ML model management associated with FIG. 4, aspects of the ML model management techniques associated with FIG. 5, aspects of ML model compatibility associated with FIG. 6, UE 700, network unit 800, method 900, and/or method 1000.

With an ML model based air interface, a UE 115 and a BS 105 may use trained ML models to implement a function (e.g., CSI reporting/estimation/prediction, beam reporting/estimation/prediction, position reporting/estimation/prediction, etc.). Unless otherwise noted, it is understood that reference to a ML model in the present disclosure includes any type of program that relies on machine learning, including ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

As an example of using ML models to implement a function, in some instances when a UE 115 intends to convey channel state information (CSI) to the BS 105, the UE 115 may use a ML model (e.g., UE-side ML model) to derive a compressed representation of the CSI to feedback to the BS 105. The BS 105 may use another ML model (e.g., network unit-side ML model) to reconstruct the CSI from the compressed representation received from the UE 115. For the reconstruction to be accurate and/or useful, the UE-side ML model and NW-side ML model may be trained in a collaborative manner so that the compressed representation received from the UE 115 is interpreted and decoded correctly by the NW-side ML model implemented by the BS 105. If this interoperability of the ML models is satisfied, then such a pair of ML models may be considered compatible. Generally speaking, a UE-side ML model may be considered compatible with a NW-side ML model if the NW-side ML model is able to successfully utilize an output and/or report from the UE-side ML model.

The signaling diagram 300 illustrates aspects of ML model management between a BS 105 and a UE 115.

At action 305, the UE 115 transmits a capability report to the BS 105. In some aspects, the capability report may include information regarding the ML model capabilities (e.g., indicating the ML model(s) the UE is running and/or able to run) and/or other capabilities of the UE.

At action 310, the BS 105 transmits a ML model configuration to the UE 115. In some instances, the BS 105 may place the UE 115 into a group of UEs based on the capability report. For example, the BS 105 may place the UE 115 in to a group of UEs based on the ML model(s) associated with the UE as indicated in the capability report. In some instances, the BS 105 may group UEs using and/or capable of using a common ML model (e.g., the same ML model), group UEs using and/or capable of using ML models compatible with a common ML model of the BS 105 (e.g., the ML models used by each UE of the group are compatible with the same ML model used by the BS 105), group UEs using and/or capable of using an ML model based on a common original ML model (e.g., the ML models used by each UE of the group are based on the same starting ML model, but may have been fine-tuned and/or otherwise refined or updated for the UE). The BS 105 may activate one or more ML model(s) for the UE 115 based on the capability report. In some instances, the BS 105 may associate the UE 115 with a corresponding group identifier (e.g., a first group identifier) based, at least in part, on the capability report received from the UE. In some aspects, the group identifier may be associated with the one or more ML model(s) activated for the UE and/or other UEs of the group of UEs. In some aspects, the BS 105 may indicate the one or more ML model(s) that have been activated in the ML model configuration. In some instances, the group identifier may be utilized to by the BS 105 to indicate the one or more ML model(s). For example, the UE 115 may utilize the group identifier to determine which ML model(s) to activate. In some instances, the indication of one or more ML model(s) may be used by the UE 115 to determine a group identifier associated with the UE 115. For example, the UE 115 may utilize the activated ML model(s) to determine (e.g., based on a rule and/or other mapping) an associated group identifier for the UE 115.

At action 315, the UE 115 implements a ML model based on the ML model configuration. In some instances, the UE may implement the ML model for CSI reporting/estimation/prediction, beam reporting/estimation/prediction, position reporting/estimation/prediction, etc. For example, the UE 115 may use a ML model (e.g., UE-side ML model) to derive a compressed representation of CSI to feedback to the BS 105.

At action 320, the UE 115 transmits a ML model report to the BS 105. The ML model report may include data associated with the ML model implemented by the UE 115. Accordingly, the ML model report may include data associated with CSI reporting/estimation/prediction, beam reporting/estimation/prediction, position reporting/estimation/prediction, etc. Continuing the CSI example, the ML model report may include the compressed representation of the CSI.

At action 325, the BS 105 implements a ML model. The ML model implemented by the BS 105 may be compatible with the MS model implemented by the UE 115. In this regard, the ML model implemented by the BS 105 may be configured to process and/or otherwise utilize the data associated with the UE-side ML model included in the ML model report. For example, the ML model implemented by the BS 105 may be configured to accurately reconstruct the CSI from the compressed representation received from the UE as part of the ML model report. In some aspects, the BS 105 does not implement a ML model compatible with the ML model implemented by the UE 115. In this regard, in some aspects the BS 105 may be configured to process and/or utilize the ML model report received from the UE 115 without implementing a ML model. For example, the ML model report transmitted by the UE 115 at action 320 may be in a format that the BS 105 may receive, successfully decode, and utilize the associated information without an ML model.

At action 330, the BS 105 transmits a communication to the UE 115. The communication may include an RRC communication, a PDCCH communication, a PDSCH communication, and/or other communications. In this regard, the communication may instruct the UE 115 to take one or more actions (e.g., switch ML models, switch to a non-ML model mode, monitor performance of an ML model, update an ML model, report data for an ML model, update one or more operating parameters, etc.) and/or allocate resources to the UE 115 (e.g., time and/or frequency resources for uplink and/or downlink communications). In some aspects, the communication transmitted at action 330 may be a group-based communication transmitted to the UE 115 and/or one or more other UEs in a group with the UE 115.

FIG. 4 illustrates a wireless communication network 400 implementing group-based ML model management according to some aspects of the present disclosure. In this regard, aspects of the wireless communication network 400 and/or the group-based ML model management shown in FIG. 4 may be utilized in the context of the wireless communication network 100 as well as with other aspects of the present disclosure, including aspects of the ML model management techniques associated with FIG. 3, aspects of the ML model management techniques associated with FIG. 5, aspects of ML model compatibility associated with FIG. 6, UE 700, network unit 800, method 900, and/or method 1000.

Among UEs associated with the same BS 105 (e.g., UEs connected to the BS 105 and/or within a geographic area associated with the BS 105), different UEs may use different UE-side ML models. In some instances, the BS 105 may group UEs into one or more groups based on the ML model(s) associated with the UEs. For example, the BS 105 may group UEs based on UEs using (or capable of using) a common ML model (e.g., the same ML model), UEs using (or capable of using) ML models compatible with a common ML model of the network unit (e.g., the ML models used by each UE of the group are compatible with the same ML model used by the network unit), UEs using (or capable of using) an ML model based on a common original ML model (e.g., the ML models used by each UE of the group are based on the same starting ML model, but may have been fine-tuned and/or otherwise refined or updated for the UE). For example, as shown, UE 115a and UE 115b may part of a UE group 405, while UE 115c, UE 115d, and UE 115e may be part of a UE group 410. While two UE groups are shown (i.e., UE group 405 and UE group 410), the concepts of the present disclosure are applicable to any number of UE groups (e.g., 1, 2, 3, 4, etc.) with any number of UEs (e.g., 1, 2, 3, 4, etc.) in each UE group.

In some aspects, to ensure correct operation and/or utilization of the ML model(s) implemented by the UEs and/or the BS 105, the BS 105 may use a network-side ML model that is compatible with the associated UE-side model. Accordingly, in some instances, the BS 105 may run multiple network-side ML models to accommodate different UE-side ML models (e.g., one network-side ML model compatible with the ML model(s) implemented by the UE group 405 and another network-side ML model compatible with the ML model(s) implemented by the UE group 410). In some instances, the BS 105 may wish to reduce the energy consumption and/or the processing complexity associated with running multiple network-side ML models. Accordingly, in some aspects the BS 105 may implement a common network-side ML model for use across multiple groups of UEs and/or all of the UEs associated with the BS 105, which may help avoid the overhead of loading parameters of different ML models for execution and reduce the processing latency and/or the power consumption of the BS 105. In some aspects, the BS 105 may want to have the UEs of both UE group 405 and UE group 410 switch to a common UE-side ML model and/or utilize a UE-side ML model that is compatible with the common network-side ML model. This allows the BS 105 to use a single network-side ML model to process ML model data from all of the UEs (e.g., UE 115a, UE 115b, UE 115c, UE 115d, and UE 115e), thereby reducing the above-mentioned overhead associated with running multiple network-side ML models. The BS 105 may indicate to each UE separately to initiate a switch to the common UE-side ML model (or UE-side model compatible with the common network-side ML model). However, in accordance with some aspects of the present disclosure the BS 105 may utilize a group-based signal to provide an indication to all of the UEs of a group in a single communication, which reduces overhead and improves network efficiency.

The BS 105 may also use a group-based signal in the context of network configuration update and/or change in network conditions. In this regard, ML Model A may be well-suited to one configuration (e.g., indoor, high signal strength situations, etc.), while ML Model B may be well-suited to another configuration (e.g., outdoor, low signal strength situations, etc.). For example, the BS 105 may use all antenna ports when the traffic load is high but may turn off one or more antennas when the traffic load is lower in an effort to save power. When the BS 105 modifies the network configuration and/or otherwise detects a change in network conditions, the BS 105 may indicate to the UEs using model A to switch to model B (or vice versa). Again, the BS 105 may provide the indication to each UE separately, but in accordance with some aspects of the present disclosure the BS 105 may utilize a group-based signal to provide the indication to all of the UEs of a group in a single communication, reducing overhead and improving network efficiency.

The BS 105 may also use a group-based signal in the context of ML model monitoring. A UE may use different ML models for different scenarios (e.g., indoor, outdoor, high signal strength, low signal strength, etc.). The BS 105 may perform a model monitoring procedure with a particular UE (e.g., UE 115c) and may determine that ML Model B used by the UE is no longer performing well. In some instances, the poor performance of ML Model B may be due to a change in the UE's scenario (e.g., moving from indoors to outdoors, moving from a higher signal strength location to a lower signal strength location, etc.). However, in some instances the UE's scenario may remain the same, but the data statistics associated with the scenario have changed (e.g., training data collected was based on assumptions/parameters that are not applicable to the current network conditions) such that the poor performance of ML Model B is likely to extend to any UE implementing ML Model B. In this case, the BS 105 may indicate to all UEs in the same scenario as UE (e.g., UE 115c) (e.g., all UEs of UE group 410) to deactivate ML Model B and either switch to a different model or fallback to a non-ML model solution. In some instances, the BS 105 may indicate to one or more of the UEs utilizing ML Model B to monitor performance of the ML Model B. The BS 105 may receive reports from the UEs regarding the performance of the ML Model B and determine whether the deactivate the ML Model B for one or more of the UEs utilizing ML Model B. Accordingly, aspects of the present disclosure may be utilized to determine whether poor performance of a ML model is UE-specific or based on an issue affecting multiple UEs (e.g., a network-side ML model switch, a network unit configuration change, data drift, etc.).

Aspects of the present disclosure provide mechanisms to keep track of groups of UEs that are assigned the same ML model and/or compatible ML models. Aspects of the present disclosure also provide mechanisms to indicate to a group of UEs to take an action (e.g., deactivate the ML model and fallback to a non-ML model solution, or switch to a different ML model) in an efficient, group-based manner.

FIG. 5 illustrates a signaling diagram for ML model management according to one or more aspects of the present disclosure. In this regard, aspects of ML model management shown in FIG. 5 may be utilized in the context of the wireless communication network 100 as well as with other aspects of the present disclosure, including aspects of the ML model management techniques associated with FIG. 3, aspects of wireless communication network 400, aspects of the group-based ML model management associated with FIG. 4, aspects of ML model compatibility associated with FIG. 6, UE 700, network unit 800, method 900, and/or method 1000.

At action 505, the BS 105 transmits one or more ML model configurations to the UE 115a and the UE 115b that are part of UE group 405. In some instances, the BS transmits a separate ML model configuration to each of UE 115a and UE 115b. The BS 105 may transmit the ML model configurations to the UE 115a and the UE 115b via a radio resource control (RRC) message or other suitable communication. In some instances, the BS 105 may place the UE 115a and the UE 115b into the UE group 405 based on capability reports or indications received from each of the UE 115a and the UE 115b. For example, the BS 105 may place the UE 115a and the UE 115b into the UE group 405 based on the ML model(s) associated with the UE 115a and the UE 115b as indicated in the capability reports/indications. In some instances, the BS 105 may group the UE 115a and UE 115b into the UE group 405 based on the UE 115a and the UE 115b using a common ML model (e.g., the same ML model), using ML models compatible with a common ML model of the BS 105 (e.g., the ML models used by each of UE 115a and 115b are compatible with the same ML model used by the BS 105), using an ML model based on a common original ML model (e.g., the ML models used by each of UE 115a and UE 115b are based on the same starting ML model, but may have been fine-tuned and/or otherwise refined or updated for each of UE 115a and UE 115b). The BS 105 may activate one or more ML model(s) for the UE 115 with the ML model configurations transmitted at action 505. In some instances, the BS 105 may indicate to the UE 115a and the UE 115b a group identifier (e.g., a first group identifier) associated with the UE group 405 in the ML model configurations. In some aspects, the group identifier associated with the UE group 405 may be based on one or more ML model(s) activated for the UE 115a and/or UE 115b of the UE group 405. In some aspects, the BS 105 may indicate the one or more ML model(s) that have been activated for the UE 115a and the UE 115b in the associated ML model configurations. In some instances, the group identifier indicated in the ML model configurations may be utilized by the BS 105 to indicate the one or more activated ML model(s). In some instances, the indication of one or more ML model(s) by the BS 105 in the ML model configurations may be used by the UE 115a and the UE 115b to determine a group identifier associated with the UE group 405. For example, the UE 115a and the UE 115b may utilize the activated ML model(s) to determine (e.g., based on a rule and/or other mapping) an associated group identifier for the UE group 405.

At action 510, the BS 105 transmits one or more ML model configurations to the UE 115c, the UE 115d, and the UE 115e that are part of UE group 410. In some instances, the BS transmits a separate ML model configuration to each of UE 115c, UE 115d, and UE 115e. The BS 105 may transmit the ML model configurations to the UE 115c, the UE 115d, and the UE 115e via a radio resource control (RRC) message or other suitable communication. In some instances, the BS 105 may place the UE 115c, the UE 115d, and the UE 115e into the UE group 410 based on capability reports or indications received from each of the UE 115c, the UE 115d, and the UE 115e. The determination of and/or contents of the ML model configurations for the UE group 410 may be similar to those discussed above for the UE group 405 at action 505 and, for sake of brevity, will not be repeated here.

At action 515, the BS 105 detects a condition. The detected condition may be a ML model change associated with the BS 105, a configuration change associated with the BS 105 (e.g., change in active antennas, change in down-tilt, change in power output, etc.), a data drift associated with one or more ML models (e.g., data distribution has drifted from the training data distribution), change in network conditions, change in UE location, and/or other condition.

At action 520, the BS 105 transmits a group-based ML model communication to one or more UEs of the UE group 405 (e.g., the UE 115a and/or the UE 115b). In some instances, the group-based ML model communication transmitted at action 520 is based on the condition detected by the BS 105 at action 515. The BS 105 may transmit the group-based ML model communication via group-common downlink control information (DCI), a PDCCH communication, a broadcast communication, a multi-cast communication, or other suitable communication.

At action 525, the one or more UEs of the UE group 405 (e.g., the UE 115a and/or the UE 115b) take one or more actions based on the group-based ML model communication received at action 520. In this regard, the one or more actions taken by the UE(s) may be based on an indication and/or instruction included in the group-based ML model communication. For example, in some aspects the group-based ML model communication may indicate for the UE(s) to switch from an active ML model. In this regard, the group-based ML model communication may include an indication to switch from the active ML model to a different ML model or switch from the active ML model to a non-ML model based mode. Accordingly, at action 525, the UE(s) may switch from the active ML model in accordance with the indication in the group-based ML model communication.

In some aspects, the group-based ML model communication indicates the UE(s) to monitor performance of an ML model. In such instances, at action 525, the UE(s) may monitor performance of the ML model and/or transmit one or more reports to the BS 105 regarding the performance of the ML model (e.g., via an RRC communication, a PUCCH communication, a PUSCH communication, or other suitable communication).

In some aspects, the group-based ML model communication indicates the UE(s) to update an ML model based on updated data. In such instances, at action 525, the UE(s) may update the ML model based on the updated data.

At action 530, in some aspects the BS 105 transmits a group-based ML model communication to one or more UEs of the UE group 410 (e.g., the UE 115c, the UE 115d, and/or the UE 115e). In some instances, the group-based ML model communication transmitted at action 530 is based on the condition detected by the BS 105 at action 515. The BS 105 may transmit the group-based ML model communication via group-common downlink control information (DCI), a PDCCH communication, a broadcast communication, a multi-cast communication, or other suitable communication.

At action 535, the one or more UEs of the UE group 410 (e.g., the UE 115c, the UE 115d, and/or the UE 115e) take one or more actions based on the group-based ML model communication received at action 530. The action(s) taken by the UEs of UE group 410 at action 535 may be similar and/or the same as those taken by the UEs of UE group 405 at action 525.

FIG. 6 illustrates a chart 600 showing ML model compatibility according to one or more aspects of the present disclosure. In this regard, aspects of ML model capability shown in FIG. 6 may be utilized in the context of the wireless communication network 100 as well as with other aspects of the present disclosure, including aspects of the ML model management techniques associated with FIG. 3, aspects of wireless communication network 400, aspects of the group-based ML model management associated with FIG. 4, aspects of the ML model management techniques associated with FIG. 5, UE 700, network unit 800, method 900, and/or method 1000.

The chart 600 includes a column 605 with network-side ML models in separate rows. The chart also includes a column 610 showing the compatible UE-side ML model(s) associated with each of the network-side ML models. For example, when the network-side ML model is Model A, the compatible UE-side ML Model(s) include Model X. When the network-side ML model is Model B, the compatible UE-side ML Model(s) include Model Y. When the network-side ML model is Model i, the compatible UE-side ML Model(s) include Model Y and Model Z. The chart 600 is a non-limiting example of how a network unit and/or UE may keep track of which UE-side ML models are compatible with which network-side ML models. However, any other suitable techniques (e.g., listings, rules, explicit indications, etc.) for determining and/or tracking compatibility may also be used. As discussed in other aspects of the present disclosure, the compatibility of the ML models may be used to group UEs into one or more UE groups, determine an associated group identifier with such UE groups, and/or determine available ML model(s) for activation.

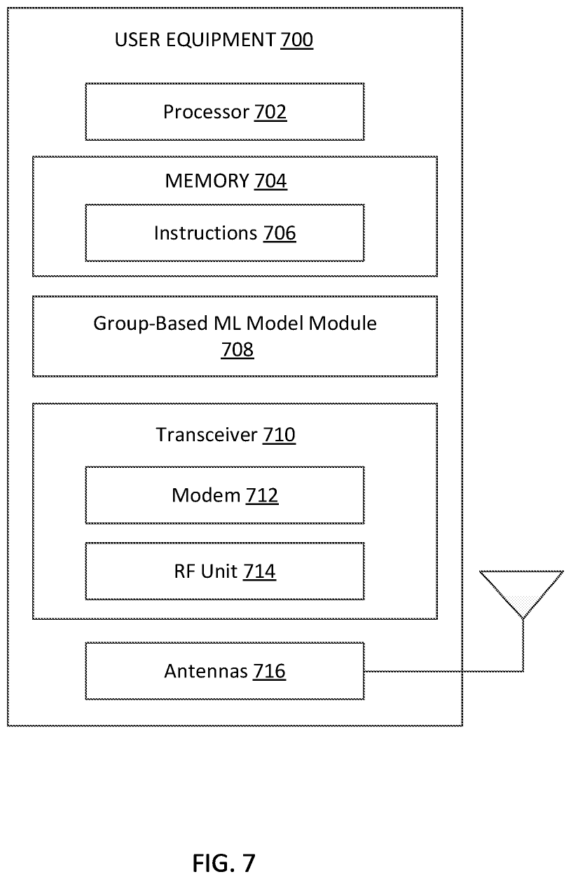

FIG. 7 is a block diagram of a UE 700 according to one or more aspects of the present disclosure. The UE 700 may be, for instance, a UE 115 as discussed in FIGS. 1-6. As shown, the UE 700 may include a processor 702, a memory 704, a group-based machine learning (ML) model module 708, a transceiver 710 including a modem subsystem 712 and an RF unit 714, and one or more antennas 716. These elements may be coupled with one another. The term “coupled” may refer to directly or indirectly coupled or connected to one or more intervening elements. For instance, these elements may be in direct or indirect communication with each other, for instance via one or more buses.

The processor 702 may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, solid state memory device, hard disk drives, other forms of volatile and non-volatile memory, or a combination of different types of memory. In an aspect, the memory 704 includes a non-transitory computer-readable medium. The memory 704 may store, or have recorded thereon, instructions 706. The instructions 706 may include instructions that, when executed by the processor 702, cause the processor 702 to perform the operations described herein with reference to a UE 115 in connection with aspects of the present disclosure, for instance, aspects of FIGS. 3-6 and 9. Instructions 706 may also be referred to as program code. The program code may be for causing a wireless communication device to perform these operations, for instance by causing one or more processors (such as processor 702) to control or command the UE 700 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The group-based ML model module 708 may be implemented via hardware, software, or combinations thereof. For instance, the group-based ML model module 708 may be implemented as a processor, circuit, and/or instructions 706 stored in the memory 704 and executed by the processor 702. In some aspects, the group-based ML model module 708 may be integrated within the modem subsystem 712. For instance, the group-based ML model module 708 may be implemented by a combination of software components (e.g., executed by a DSP or a general processor) and hardware components (e.g., logic gates and circuitry) within the modem subsystem 712. The group-based ML model module 708 may communicate with one or more components of the UE 700 to implement various aspects of the present disclosure, for instance, aspects of FIGS. 3-6 and 9.

In some aspects, the group-based ML model module 708 may be configured, along with other components of the UE 700, to receive, from a network unit, an indication of a first group identifier associated with the UE, wherein the first group identifier is based, at least in part, on one or more machine learning (ML) models associated with the UE. In some aspects, the group-based ML model module 708 may be configured, along with other components of the UE 700, to receive, from the network unit, a group-based signal associated with the first group identifier. In some aspects, the group-based ML model module 708 may be configured, along with other components of the UE 700, to monitor, in response to receiving the group-based signal, the performance of the ML model. In some aspects, the group-based ML model module 708 may be configured, along with other components of the UE 700, to transmit, to the network unit, a report associated with the monitoring the performance of the ML model. In some aspects, the group-based ML model module 708 may be configured, along with other components of the UE 700, to transmit, to the network unit, a capability indication.

In some aspects, the group-based ML model module 708 is further configured to run one or more ML models. In this regard, the group-based ML model module 708 may be configured, along with other components of the UE 700, to execute any type of program that relies on machine learning, including ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

As shown, the transceiver 710 may include the modem subsystem 712 and the RF unit 714. The transceiver 710 may be configured to communicate bi-directionally with other devices, such as the BSs 105 and/or network units. The modem subsystem 712 may be configured to modulate and/or encode the data from the memory 704 and/or the group-based ML model module 708 according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., communication signals, data signals, control signals, capability reports, ML model monitoring reports, ML model data, etc.) from the modem subsystem 712 (on outbound transmissions). The RF unit 714 may be further configured to perform analog beamforming in conjunction with the digital beamforming. Although shown as integrated together in transceiver 710, the modem subsystem 712 and the RF unit 714 may be separate devices that are coupled together at the UE 700 to enable the UE 700 to communicate with other devices.

The RF unit 714 may provide the modulated and/or processed data, e.g., data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The transceiver 710 may provide the demodulated and decoded data (e.g., communication signals, data signals, control signals, group-based signals, machine learning (ML) model configurations, ML model monitoring requests, group-based ML model instructions, etc.) to the group-based ML model module 708 for processing. The antennas 716 may include multiple antennas of similar or different designs in order to sustain multiple transmission links.

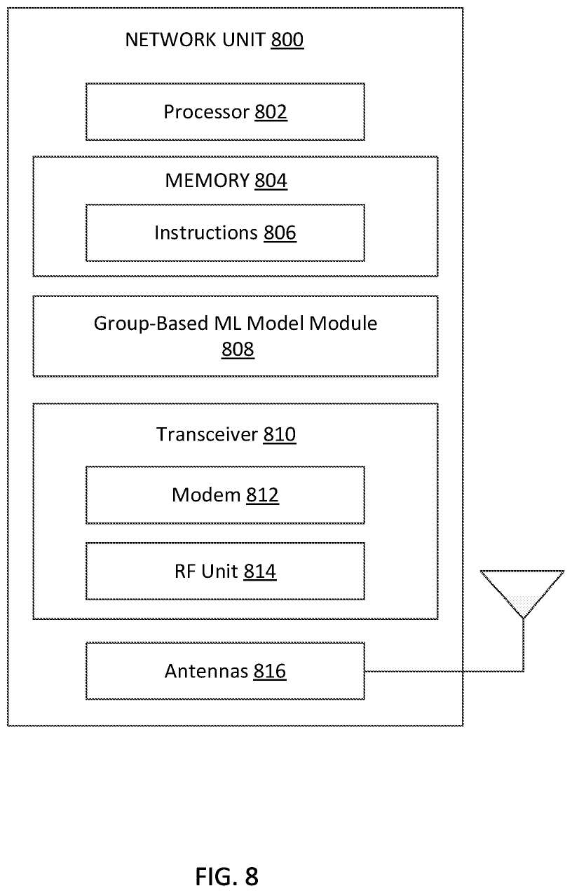

FIG. 8 is a block diagram of a network unit 800 according to one or more aspects of the present disclosure. The network unit 800 may be a BS 105, CU 210, DU 230, and/or RU 240 as discussed in FIGS. 1-6. Accordingly, the network unit 800 may include a BS. The BS may be an aggregated BS or a disaggregated BS, as described above. As shown, the network unit 800 may include a processor 802, a memory 804, a group-based machine learning (ML) module 808, a transceiver 810 including a modem subsystem 812 and a radio frequency (RF) unit 814, and one or more antennas 816. These elements may be coupled with one another. The term “coupled” may refer to directly or indirectly coupled or connected to one or more intervening elements. For instance, these elements may be in direct or indirect communication with each other, for instance via one or more buses.

The processor 802 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 804 may include a non-transitory computer-readable medium. The memory 804 may store instructions 806. The instructions 806 may include instructions that, when executed by the processor 802, cause the network unit 800 to perform operations described herein, for instance, aspects of FIGS. 3-6 and 10. Instructions 806 may also be referred to as program code. The program code may be for causing a wireless communication device to perform these operations, for instance by causing one or more processors (such as processor 802) to control or command the network unit 800 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The group-based ML model module 808 may be implemented via hardware, software, or combinations thereof. For instance, the group-based ML model module 808 may be implemented as a processor, circuit, and/or instructions 806 stored in the memory 804 and executed by the processor 802. In some instances, the group-based ML model module 808 may be integrated within the modem subsystem 812. For instance, the group-based ML model module 808 may be implemented by a combination of software components (e.g., executed by a DSP or a general processor) and hardware components (e.g., logic gates and circuitry) within the modem subsystem 812. The group-based ML model module 808 may communicate with one or more components of the network unit 800 to implement various aspects of the present disclosure, for instance, aspects of FIGS. 3-6 and 10.

In some aspects, the group-based ML model module 808 may be configured, along with other components of the network unit 800, to transmit, to one or more first user equipments (UEs), an indication of a first group identifier, wherein the first group identifier is based, at least in part, on one or more first machine learning (ML) models associated with the one or more first UEs. In some aspects, the group-based ML model module 808 may be configured, along with other components of the network unit 800, to transmit, to at least one UE of the one or more first UEs, a first group-based signal associated with the first group identifier. In some aspects, the group-based ML model module 808 may be configured, along with other components of the network unit 800, to determine to transmit the first group-based signal based on at least one of a ML model change associated with the network unit; a configuration change associated with the network unit; or a data drift associated with the one or more first ML models. In some aspects, the group-based ML model module 808 may be configured, along with other components of the network unit 800, to receive, from the at least one UE of the one or more first UEs in response to the first group-based signal indicating to monitor performance of an ML model, a report associated with the performance of the ML model. In some aspects, the group-based ML model module 808 may be configured, along with other components of the network unit 800, to transmit, to one or more second UEs, an indication of a second group identifier different than the first group identifier, wherein the second group identifier is based, at least in part, on one or more second ML models associated with the one or more second UEs and transmit, to at least one UE of the one or more second UEs, a second group-based signal associated with the second group identifier. In some aspects, the group-based ML model module 808 may be configured, along with other components of the network unit 800, to receive, from each UE of the one or more first UEs, a capability indication and associate each UE of the one or more first UEs with the first group identifier based, at least in part, on the capability indication received from each UE.

As shown, the transceiver 810 may include the modem subsystem 812 and the RF unit 814. The transceiver 810 may be configured to communicate bi-directionally with other devices, such as the UE 115, UE 700, and/or another network unit. The modem subsystem 812 may be configured to modulate and/or encode data according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data (e.g., communication signals, data signals, control signals, group-based signals, machine learning (ML) model configurations, ML model monitoring requests, group-based ML model instructions, etc.) from the modem subsystem 812 (on outbound transmissions). The RF unit 814 may be further configured to perform analog beamforming in conjunction with the digital beamforming. Although shown as integrated together in transceiver 810, the modem subsystem 812, and/or the RF unit 814 may be separate devices that are coupled together at the network unit 800 to enable the network unit 800 to communicate with other devices.

The RF unit 814 may provide the modulated and/or processed data, e.g., data packets (or, more generally, data messages that may contain one or more data packets and other information), to the antennas 816 for transmission to one or more other devices. The antennas 816 may further receive data messages transmitted from other devices and provide the received data messages for processing and/or demodulation at the transceiver 810. The transceiver 810 may provide the demodulated and decoded data (e.g., communication signals, data signals, control signals, capability reports, ML model monitoring reports, ML model data, etc.) to the group-based ML model module 808 for processing. The antennas 816 may include multiple antennas of similar or different designs in order to sustain multiple transmission links.

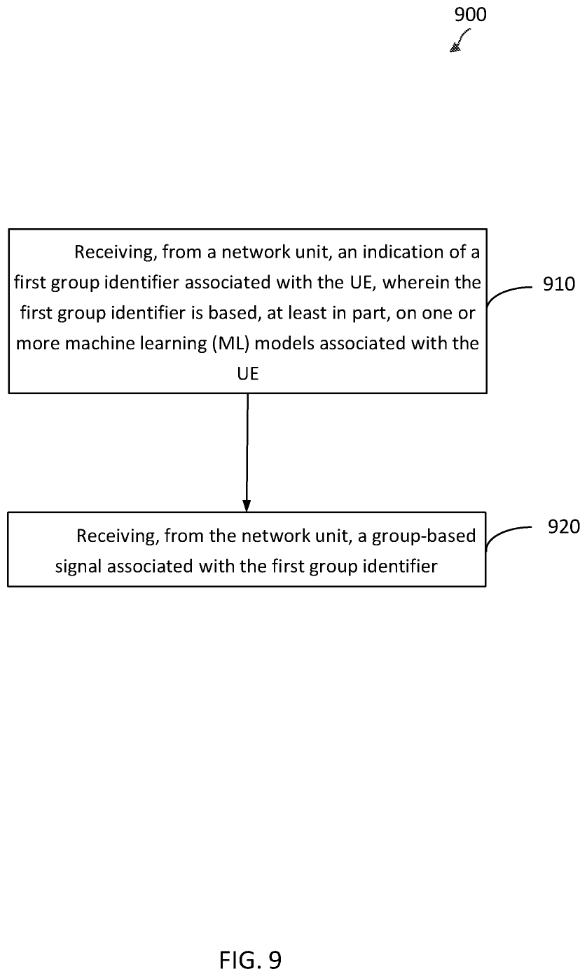

FIG. 9 is a flow diagram illustrating a wireless communication method 900 according to one or more aspects of the present disclosure. Aspects of the method 900 may be executed by a computing device (e.g., a processor, processing circuit, and/or other suitable component) of a wireless communication device or other suitable means for performing the blocks. For instance, the wireless communication device may be a UE (e.g., UE 115 or UE 700). The UE may utilize one or more components, such as the processor 702, the memory 704, the group-based ML model module 708, the transceiver 710, the modem subsystem 712, the RF unit 714, and/or the one or more antennas 716, to execute the blocks of method 900. The method 900 may employ similar mechanisms as described in FIGS. 3-6. As illustrated, the method 900 includes a number of enumerated blocks, but aspects of the method 900 may include additional blocks before, after, and in between the enumerated blocks. In some aspects, one or more of the enumerated blocks may be omitted or performed in a different order.

At block 910, the UE (e.g., UE 115 and/or UE 700) receives an indication of a first group identifier associated with the UE. The UE may receive the indication of the first group identifier from a network unit (e.g., network unit 800, BS 105, CU 210, DU 230, and/or RU 240). The UE may receive the indication of the first group identifier from the network unit via a radio resource control (RRC) message or other suitable communication.

The first group identifier may be based, at least in part, on one or more machine learning (ML) models associated with the UE. In some instances, the ML model(s) may be a common ML model activated for one or more other UEs associated with the first group identifier. In some instances, the ML model(s) may be compatible with a common ML model associated with the network unit. In some instances, each of the first ML model(s) is based on a common ML model associated with one or more other UEs associated with the first group identifier. For example, the ML model(s) of the UE and the other UEs may be based on the same original ML model but fine-tuned and/or otherwise refined or updated for each UE.

At block 920, the UE receives, from the network unit, a group-based signal associated with the first group identifier. In some aspects, the group-based signal indicates to the UE to switch from an active ML model. In this regard, the group-based signal may include an indication to switch from the active ML model to a different ML model or switch from the active ML model to a non-ML model based mode. In some instances, the group-based signal further indicates a second group identifier different than the first group identifier. The second group identifier may be associated with the different ML model and/or the non-ML model based mode indicated in the first group-based signal. In some aspects, the inclusion of the second group identifier may be the indication for the UE to switch from the active ML model. In some aspects, the UE may receive the group-based signal in response to at least one of a ML model change associated with the network unit; a configuration change associated with the network unit; or a data drift associated with the one or more ML models.

In some aspects, the group-based signal indicates to the UE to monitor performance of an ML model. The ML model may be an active ML model currently run by the UE or another ML model the UE is capable of running. The network unit may receive, from the at least one UE of the one or more first UEs in response to the first group-based signal, a report associated with the performance of the ML model. The UE, in response to receiving the group-based signal, may monitor the performance of the ML model. The UE may collect new data associated with the ML model and/or report the new data (or an indication thereof) to the network unit. In some aspects, the UE transmits, to the network unit, a report associated with the monitoring the performance of the ML model. The UE may transmit the report via an RRC communication, a PUCCH communication, a PUSCH communication, or other suitable communication.

In some aspects, the group-based signal indicates to the UE to update an ML model based on updated data. In some instances, the updated data may be based on data collected by one or more other UEs associated with the first group identifier. For example, in response to monitoring the performance of an ML model, one or more UEs may collect updated data and report the updated data to the network unit. The network unit may determine that all of the UEs in the group (e.g., associated with the first group identifier) should update the ML model based on the updated data and transmit the group-based signal indicating to update the ML model based on the updated data.

In some aspects, the UE may transmit to the network unit a capability indication. The capability indication may include information regarding the ML model capabilities (e.g., indicating the ML model(s) the UE is running and/or able to run) and/or other capabilities of the UE. In some instances, the network unit may group UEs into one or more groups based on the ML model(s) associated with the UEs. For example, the network unit may group the UE with other UEs based on the UEs using a common ML model (e.g., the same ML model), the UEs using ML models compatible with a common ML model of the network unit (e.g., the ML models used by each UE of the group are compatible with the same ML model used by the network unit; see FIG. 6), the UEs using an ML model based on a common original ML model (e.g., the ML models used by each UE of the group are based on the same starting ML model, but may have been fine-tuned and/or otherwise refined or updated for the UE). The network unit may associate the UE with a corresponding group identifier (e.g., the first group identifier) based, at least in part, on the capability indication received from the UE.

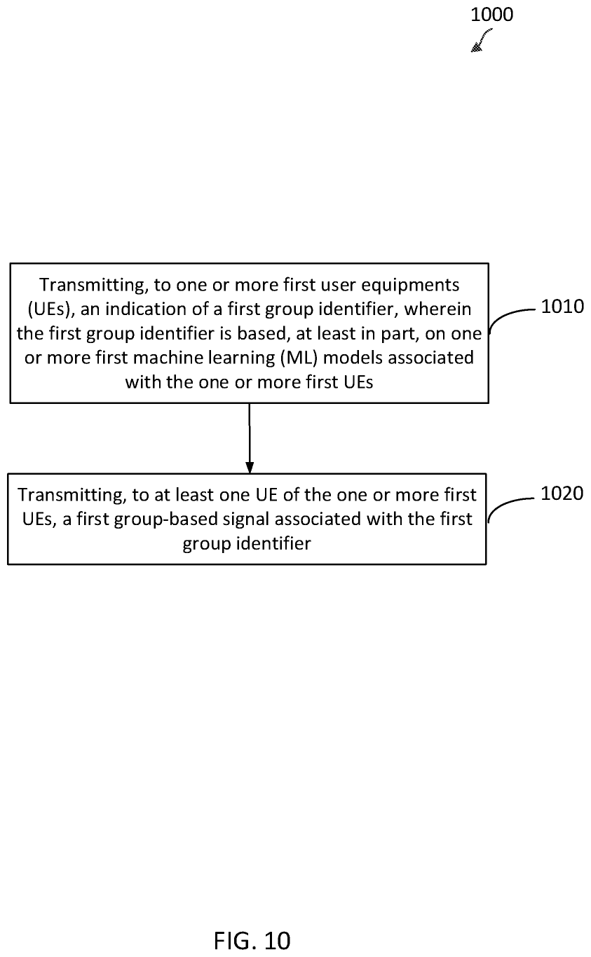

FIG. 10 is a flow diagram illustrating a wireless communication method 1000 according to one or more aspects of the present disclosure. Aspects of the method 1000 may be executed by a computing device (e.g., a processor, processing circuit, and/or other suitable component) of a wireless communication device or other suitable means for performing the blocks. For instance, the wireless communication device may include a network unit (e.g., network unit 800, BS 105, CU 210, DU 230, and/or RU 240). The network unit 800 may utilize one or more components, such as the processor 802, the memory 804, the group-based ML model module 808, the transceiver 810, the modem subsystem 812, the RF unit 814, and/or the one or more antennas 816, to execute the blocks of method 1000. The method 1000 may employ similar mechanisms as described in FIGS. 3-6. As illustrated, the method 1000 includes a number of enumerated blocks, but aspects of the method 1000 may include additional blocks before, after, and in between the enumerated blocks. In some aspects, one or more of the enumerated blocks may be omitted or performed in a different order.

In some aspects, the network unit may group UEs into one or more groups and transmit an indication of the associated group identifier to each group of UEs. Accordingly, in some instances, the network unit may receive a capability indication for each of a plurality of UEs, where the capability indication includes information regarding the ML model capabilities (e.g., indicating the ML model(s) the UE is running and/or able to run) and/or other capabilities of the UE. In some instances, the network unit may group the UEs into one or more groups based on the ML model(s) associated with the UEs. For example, the network unit may group the UEs based on one or more of UEs using a common ML model (e.g., the same ML model), UEs using ML models compatible with a common ML model of the network unit (e.g., the ML models used by each UE of the group are compatible with the same ML model used by the network unit; see FIG. 6), UEs using an ML model based on a common original ML model (e.g., the ML models used by each UE of the group are based on the same starting ML model, but may have been fine-tuned and/or otherwise refined or updated for the UE). The network unit may associate each UE with a corresponding group identifier based, at least in part, on the capability indication received from each UE.

At block 1010, the network unit (network unit 800, BS 105, CU 210, DU 230, and/or RU 240) transmits an indication of a first group identifier. The network unit may transmit the indication of the first group identifier to one or more first UEs (e.g., UE 115, UE 700, UE group 405, and/or UE group 410). The network unit may transmit the first group identifier to the first UE(s) via a radio resource control (RRC) message or other suitable communication.

The first group identifier may be based, at least in part, on one or more machine learning (ML) models associated with the first UE(s). In some instances, each of the first ML model(s) is a common ML model activated for each of the first UE(s). In some instances, each of the first ML model(s) is compatible with a common ML model associated with the network unit. In some instances, each of the first ML model(s) is based on a common ML model. For example, each of the first ML model(s) may be based on the same original ML model but fine-tuned and/or otherwise refined or updated for one or more of the first UE(s).

In some aspects, the network unit may transmit an indication of a second group identifier different than the first group identifier. The network unit may transmit the indication of the second group identifier to one or more second UEs (e.g., UE 115, UE 700, UE group 405, and/or UE group 410). The network unit may transmit the second group identifier to the first UE(s) via a radio resource control (RRC) message or other suitable communication.

The second group identifier may be based, at least in part, on one or more second ML models associated with the second UE(s). In some instances, each of the second ML model(s) is a common ML model activated for each of the second UE(s). In some instances, each of the second ML model(s) is compatible with a common ML model associated with the network unit. In some instances, each of the second ML model(s) is based on a common ML model. For example, each of the second ML model(s) may be based on the same original ML model but fine-tuned and/or otherwise refined or updated for one or more of the second UE(s).

In some aspects, the first group identifier and the second group identifier may be utilized by the network unit to communicate with the first UE(s) and the second UE(s), respectively. For example, the network unit may include the first group identifier (or an indication thereof) in group-based signals intended for one or more of the first UE(s) and include the second group identifier (or an indication thereof) in group-based signals intended for the one or more of the second UE(s). In this manner, the network unit may manage ML model operations, including any associated and/or related parameters, and/or other aspects of the wireless communication network in a group-based manner. In this regard, the network unit may utilize a group-based signal to indicate to switch from an active ML model to a different ML model (or switch to non-ML model based operation), indicate to monitor performance of an ML model, indicate to update an ML model (e.g., based on updated data and/or parameters), and/or indicate to take a particular action. In some aspects, the network unit may determine to transmit the group-based signal based on a ML model change associated with the network unit, a configuration change associated with the BS 105 (e.g., change in active antennas, change in down-tilt, change in power output, etc.), a data drift associated with one or more ML models (e.g., data distribution has drifted from the training data distribution), change in network conditions, change in UE location, and/or other factors.

At block 1020, the network unit transmits, to at least one UE of the one or more first UEs, a first group-based signal associated with the first group identifier. The network unit may transmit the first group-based signal via group-common downlink control information (DCI), a PDCCH communication, a broadcast communication, a multi-cast communication, or other suitable communication.

In some aspects, the network unit transmits, to the at least one of the one or more first UEs, the first group-based signal indicating to switch from an active ML model. In this regard, the first group-based signal may include an indication to switch from the active ML model to a different ML model or switch from the active ML model to a non-ML model based mode. In some instances, the first group-based signal further indicates a second group identifier different than the first group identifier. The second group identifier may be associated with the different ML model and/or the non-ML model based mode indicated in the first group-based signal. In some aspects, the inclusion of the second group identifier may be the indication to the first UE(s) to switch from the active ML model. In some aspects, the network unit determines to transmit the first group-based signal based on at least one of a ML model change associated with the network unit; a configuration change associated with the network unit; or a data drift associated with the one or more first ML models.

In some aspects, the network unit transmits, to the at least one UE of the one or more first UEs, the first group-based signal indicating to monitor performance of an ML model. The ML model may be an active ML model currently run by the UE(s) or another ML model the UE(s) are capable of running. The network unit may receive, from the at least one UE of the one or more first UEs in response to the first group-based signal, a report associated with the performance of the ML model. The network unit may receive the report via an RRC communication, a PUCCH communication, a PUSCH communication, or other suitable communication.

In some aspects, the network unit transmits, to the at least one of the one or more first UEs, the first group-based signal indicating to update an ML model based on updated data. In some instances, the updated data may be based on data collected by one or more other UEs of the same group of UEs. For example, in response to monitoring the performance of an ML model, one or more UEs may collect updated data and report the updated data to the network unit. The network unit may determine that all of the UEs in the group should update the ML model based on the updated data and transmit the first group-based signal indicating to update the ML model.

In some instances, the network unit may transmit, to at least one UE of the one or more second UEs, a second group-based signal associated with the second group identifier. The network unit may transmit the second group-based signal via group-common downlink control information (DCI), a PDCCH communication, a broadcast communication, a multi-cast communication, or other suitable communication. The second group-based signal may be utilized by the network unit in a similar manner to the first group-based signal described above to provide indications and/or instructions to one or more UEs in the group of second UEs.

Other aspects of the present disclosure include:

Clause 1. A method of wireless communication performed by a network unit, the method comprising:
transmitting, to one or more first user equipments (UEs), an indication of a first group identifier, wherein the first group identifier is based, at least in part, on one or more first machine learning (ML) models associated with the one or more first UEs; and
transmitting, to at least one UE of the one or more first UEs, a first group-based signal associated with the first group identifier.

Clause 2. The method of clause 1, wherein each of the one or more first ML models comprises a common ML model activated for each of the one or more first UEs.

Clause 3. The method of any of clauses 1-2, wherein each of the one or more first ML models is compatible with a common ML model associated with the network unit.

Clause 4. The method of any of clauses 1 or 3, wherein each of the one or more first ML models is based on a common ML model.

Clause 5. The method of any of clauses 1-4, wherein the transmitting the first group-based signal comprises:
transmitting, to the at least one of the one or more first UEs, the first group-based signal indicating to switch from an active ML model.

Clause 6. The method of clause 5, wherein the first group-based signal indicates at least one of:
switch from the active ML model to a different ML model; or
switch from the active ML model to a non-ML model based mode.

Clause 7. The method of any of clauses 5 or 6, further comprising:
determining to transmit the first group-based signal based on at least one of:
   a ML model change associated with the network unit;
   a configuration change associated with the network unit; or
   a data drift associated with the one or more first ML models.

Clause 8. The method of any of clauses 5-7, wherein the first group-based signal further indicates a second group identifier different than the first group identifier.

Clause 9. The method of any of clauses 1-4, wherein the transmitting the first group-based signal comprises:
transmitting, to the at least one UE of the one or more first UEs, the first group-based signal indicating to monitor performance of an ML model.

Clause 10. The method of clause 9, further comprising:
receiving, from the at least one UE of the one or more first UEs in response to the first group-based signal, a report associated with the performance of the ML model.

Clause 11. The method of any of clauses 1-4, wherein the transmitting the first group-based signal comprises:
transmitting, to the at least one of the one or more first UEs, the first group-based signal indicating to update an ML model based on updated data.

Clause 12. The method of any of clauses 1-11, further comprising:
transmitting, to one or more second UEs, an indication of a second group identifier different than the first group identifier, wherein the second group identifier is based, at least in part, on one or more second ML models associated with the one or more second UEs; and
transmitting, to at least one UE of the one or more second UEs, a second group-based signal associated with the second group identifier.

Clause 13. The method of any of clauses 1-12, further comprising:
receiving, from each UE of the one or more first UEs, a capability indication; and
associating each UE of the one or more first UEs with the first group identifier based, at least in part, on the capability indication received from each UE.

Clause 14. A method of wireless communication performed by a user equipment (UE), the method comprising:
receiving, from a network unit, an indication of a first group identifier associated with the UE, wherein the first group identifier is based, at least in part, on one or more machine learning (ML) models associated with the UE; and
receiving, from the network unit, a group-based signal associated with the first group identifier.

Clause 15. The method of clause 14, wherein the one or more ML models comprises a common ML model activated for one or more other UEs associated with the first group identifier.

Clause 16. The method of any of clauses 14-15, wherein an active ML model of the one or more ML models is compatible with a common ML model associated with the network unit.

Clause 17. The method of any of clauses 14 or 16, wherein an active ML model of the one or more ML models is based on a common ML model associated with one or more other UEs associated with the first group identifier.

Clause 18. The method of any of clauses 14-17, wherein the receiving the group-based signal comprises:
receiving, from the network unit, the group-based signal indicating to switch from an active ML model.

Clause 19. The method of clause 18, wherein the group-based signal indicates at least one of:
switch from the active ML model to a different ML model; or
switch from the active ML model to a non-ML model based mode.

Clause 20. The method of any of clauses 18-19, wherein the group-based signal further indicates a second group identifier different than the first group identifier.

Clause 21. The method of any of clauses 14-17, wherein the receiving the group-based signal comprises:
receiving, from the network unit, the group-based signal indicating to monitor performance of an ML model.

Clause 22. The method of clause 21, further comprising:
monitoring, in response to receiving the group-based signal, the performance of the ML model; and
transmitting, to the network unit, a report associated with the monitoring the performance of the ML model.

Clause 23. The method of any of clauses 14-17, wherein the receiving the group-based signal comprises:
receiving, from the network unit, the group-based signal indicating to update an ML model based on updated data.

Clause 24. The method of any of clauses 14-23, further comprising:
transmitting, to the network unit, a capability indication; and
wherein the group identifier is further based, at least in part, on the capability indication.

Clause 25. A non-transitory computer-readable medium storing one or more instructions for wireless communication, the one or more instructions comprising one or more instructions that, when executed by one or more processors of a network unit, cause the network unit to perform any one or more aspects of clauses 1-13.

Clause 26. A non-transitory computer-readable medium storing one or more instructions for wireless communication, the one or more instructions comprising one or more instructions that, when executed by one or more processors of a UE, cause the UE to perform any one or more aspects of clauses 14-24.

Clause 27. A network unit comprising one or more means to perform any one or more aspects of clauses 1-13.

Clause 28. A user equipment (UE) comprising one or more means to perform any one or more aspects of clauses 14-24.

Clause 29. A network unit comprising: a memory; a transceiver; and at least one processor coupled to the memory and the transceiver, wherein the network unit is configured to perform any one or more aspects of clauses 1-13.

Clause 30. A user equipment (UE) comprising: a memory; a transceiver; and at least one processor coupled to the memory and the transceiver, wherein the UE is configured to perform any one or more aspects of clauses 14-24.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations may be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

1. A user equipment (UE), comprising:
a memory device;
a transceiver; and
a processor in communication with the processor and the transceiver, wherein the UE is configured to:
receive, from a network unit, an indication of a first group identifier associated with the UE, wherein the first group identifier is based, at least in part, on one or more machine learning (ML) models associated with the UE; and
receive, from the network unit, a group-based signal associated with the first group identifier.

2. The UE of claim 1, wherein the UE is configured to receive the group-based signal indicating to switch from an active ML model.

3. The UE of claim 2, wherein the UE is further configured to:
switch, based on the group-based signal, from the active ML model to a different ML model; or
switch, based on the group-based signal, from the active ML model to a non-ML model based mode.

4. The UE of claim 2, wherein the UE is further configured to receive the group-based signal further indicating a second group identifier different than the first group identifier.

5. The UE of claim 1, wherein the UE is configured to receive the group-based signal indicating to monitor performance of an ML model.

6. (canceled)

7. The UE of claim 1, wherein the UE is further configured to:
receive the group-based signal indicating to update an ML model based on updated data; and
update, in response to receiving the group-based signal, the ML model.

8. The UE of claim 1, wherein the UE is further configured to:
transmit, to the network unit, a capability indication; and
wherein the group identifier is further based, at least in part, on the capability indication.

9. A network unit, comprising:
a memory device;
a transceiver; and
a processor in communication with the processor and the transceiver, wherein the network unit is configured to:
transmit, to one or more first user equipments (UEs), an indication of a first group identifier, wherein the first group identifier is based, at least in part, on one or more first machine learning (ML) models associated with the one or more first UEs; and
transmit, to at least one UE of the one or more first UEs, a first group-based signal associated with the first group identifier.

10. The network unit of claim 9, wherein each of the one or more first ML models comprises a common ML model activated for each of the one or more first UEs.

11. The network unit of claim 9, wherein each of the one or more first ML models is compatible with a common ML model associated with the network unit.

12. The network unit of claim 9, wherein each of the one or more first ML models is based on a common ML model.

13. The network unit of claim 9, wherein the network unit is further configured to:
transmit, to the at least one UE of the one or more first UEs, the first group-based signal indicating to switch from an active ML model.

14-16. (canceled)

17. The network unit of claim 9, wherein the network unit is further configured to:
transmit, to the at least one UE of the one or more first UEs, the first group-based signal indicating to monitor performance of an ML model.

18. (canceled)

19. The network unit of claim 9, wherein the network unit is further configured to:
transmit, to the at least one UE of the one or more first UEs, the first group-based signal indicating to update an ML model based on updated data.

20. The network unit of claim 9, wherein the network unit is further configured to:
transmit, to one or more second UEs, an indication of a second group identifier different than the first group identifier, wherein the second group identifier is based, at least in part, on one or more second ML models associated with the one or more second UEs; and
transmit, to at least one UE of the one or more second UEs, a second group-based signal associated with the second group identifier.

21. The network unit of claim 9, wherein the network unit is further configured to:
receive, from each UE of the one or more first UEs, a capability indication; and
associating each UE of the one or more first UEs with the first group identifier based, at least in part, on the capability indication received from each UE.

22. A method of wireless communication performed by a user equipment (UE), the method comprising:
receiving, from a network unit, an indication of a first group identifier associated with the UE, wherein the first group identifier is based, at least in part, on one or more machine learning (ML) models associated with the UE; and
receiving, from the network unit, a group-based signal associated with the first group identifier.

23. The method of claim 22, wherein the one or more ML models comprises a common ML model activated for one or more other UEs associated with the first group identifier.

24. The method of claim 22, wherein an active ML model of the one or more ML models is compatible with a common ML model associated with the network unit.

25. The method of claim 22, wherein an active ML model of the one or more ML models is based on a common ML model associated with one or more other UEs associated with the first group identifier.

26-30. (canceled)
